(19) United States
(12) Patent Application Publication
(10) Pub. No.: US 2006/0158990 A1
(43) Pub. Date: Jul. 20, 2006

(54) Converging optical apparatus, optical pickup and optical disc apparatus

(75) Inventor: Satoshi Hineno, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/311,238

(22) Filed: Dec. 20, 2005

(30) Foreign Application Priority Data
Dec. 28, 2004 (JP) 2004-381517
Mar. 10, 2005 (JP) 2005-067819

(51) Int. Cl. G11B 7/00

(52) U.S. Cl. 369/112.1; 369/112.15

(57) ABSTRACT

A converging optical apparatus reduces the diffraction loss and realizes compatibility with three different wavelengths by means of a hologram element. The present invention provides an optical pickup for recording signals on and/or reproducing signals from a plurality of optical discs having respective protection substrates of different thicknesses for protecting the recording surfaces thereof by means of light beams of different wavelengths, the optical pickup including a first emission section that emits a light beam of a first wavelength, a second emission section that emits a light beam of a second wavelength, a third emission section that emits a light beam of a third wavelength, an objective lens for converging the light beams of the first through third wavelengths emitted respectively from the first through third emission sections on the signal recording surfaces of the optical discs, and a hologram element arranged between the first through third emission sections and the objective lens, the hologram element having two major surfaces, wherein the hologram element is provided with a reference curved surface on one of the major surfaces thereof, the reference curved surface being an aspherical shape, and a hologram section is formed on the reference curved surface.

### CROSS REFERENCES TO RELATED APPLICATIONS

The present invention contains subject matter related to Japanese Patent Application JP 2004-381517 filed in the Japanese Patent Office on Dec. 28, 2004, and Japanese Patent Application JP 2005-067819 filed in the Japanese Patent Office on Mar. 10, 2005, the entire contents of which being incorporated by reference.

### BACKGROUND OF THE INVENTION

1. Field of the Invention

This invention relates to a converging optical apparatus and an optical pickup that can record information signals on and reproduce information signals from a disc-shaped recording medium of any of three different types by means of a single objective lens and also to an optical disc apparatus using the same.

2. Description of the Related Art

Optical discs adapted to high density recording and reproduction of signals by means of a light beam with a wavelength of about 405 nm emitted from a blue-purple semiconductor laser (to be referred to as high density recording optical discs hereinafter) have been proposed. Additionally, high density recording optical discs having a cover layer of a thickness as small as 0.1 mm for protecting the signal recording layer have also been proposed.

From the viewpoint of providing an optical pickup for such high density recording optical discs, it may be desirable that the optical pickup is compatible with optical discs of different formats including CDs (compact discs) that require the use of a laser beam with a wavelength of about 780 nm and DVDs (digital versatile discs) that require the use of a laser beam with a wavelength of about 660 nm. In other words, there is a demand for optical pickups and optical disc apparatus that are compatible with optical discs of different formats in terms of disc structure and related laser specifications.

Methods of recording information signals on and reproducing information signals from an optical disc of any of the three different types, or formats, by selectively using either of two optical systems of different types, one for DVDs and CDs and the other for high density recording optical discs, switching the objective lenses depending on the wavelength to be used are known.

However, providing two optical systems means that a switching mechanism is required to selectively use any of objective lenses of a plurality of different types. Additionally two actuators and other related parts of two different types are required. Such an arrangement baffles efforts for downsizing the apparatus and makes the entire structure a very complex one.

On the other hand, an optical pickup that is compatible with three different wavelengths is required for downsizing the apparatus. To realize such an optical pickup, it is necessary to use a common light path for the three wavelengths and the objective lens needs to be formed in such a way that it does not give rise to any aberration regardless of the use of light beams of the different wavelengths and optical discs of different types having different thicknesses.

An optical pickup that is compatible with three different wavelengths can conceivably be realized by combining an objective lens and a diffraction element. It may be conceivable to use a diffraction element having a hologram section showing a blaze-like or stepped profile on both surfaces thereof for such an optical pickup. Such a diffraction element can be used for light beams with a degree of diffraction that varies depending on the wavelength of light beam.

For example, a diffraction element described in Patent Document 1 [Jpn. Pat. Appln. Laid-Open Publication No. 2003-177226] can emit light beams with different degrees of diffraction for two different wavelengths.

While an optical pickup having such a diffraction element and an objective lens can correct the aberration attributable to the thickness of disc by means of the diffraction element, there can arise a problem of a reduced quantity of light due to the diffraction efficiency at both surfaces of the diffraction element.

Thus, it has been very difficult to realize an optical pickup compatible with high density recording optical discs, DVDs and CDs that use different wavelengths and capable of achieving excellent recording/reproduction performances relative to optical discs because of various problems including the problem of a reduced quantity of light due to diffraction losses.

### SUMMARY OF THE INVENTION

It is therefore desirable to provide a converging optical apparatus, an optical pickup and an optical disc apparatus that can reduce the diffraction loss due to a hologram element and improve the diffraction efficiency to achieve excellent recording/reproduction performances by realizing compatibility with three different wavelengths by means of a hologram section arranged on only one of the two surfaces of the hologram element.

According to the present invention, there is provided a converging optical apparatus including an objective lens for converging light beams of first through third wavelengths emitted from a light source section on the signal recording surfaces of optical discs, and a hologram element arranged between the light source section and the objective lens, the hologram element having two major surfaces, wherein the hologram element is provided with a reference curved surface on one of the major surfaces thereof, the reference curved surface being an aspherical shape, and a hologram section is formed on the reference curved surface.

According to the present invention, there is also provided an optical pickup for recording signals on and/or reproducing signals from a plurality of optical discs having respective protection substrates of different thicknesses for protecting the recording surfaces thereof by means of light beams of different wavelengths, the optical pickup including a first emission section that emits a light beam of a first wavelength, a second emission section that emits a light beam of a second wavelength, a third emission section that emits a light beam of a third wavelength, an objective lens for converging the light beams of the first through third wavelengths emitted respectively from the first through third emission sections on the signal recording surfaces of the optical discs, and a hologram element arranged between the first through third emission sections and the objective lens, the hologram element having two major surfaces, wherein the hologram element is provided with a reference curved surface on one of the major surfaces thereof, the reference curved surface being an aspherical shape, and a hologram section is formed on the reference curved surface.

According to the present invention, there is also provided an optical disc apparatus including an optical pickup for recording signals on and/or reproducing signals from a plurality of optical discs having respective protection substrates of different thicknesses for protecting the recording surfaces thereof, and disc rotary drive means for driving an optical disc to rotate, wherein the optical pickup includes a first emission section that emits a light beam of a first wavelength, a second emission section that emits a light beam of a second wavelength, a third emission section that emits a light beam of a third wavelength, an objective lens for converging the light beams of the first through third wavelengths emitted respectively from the first through third emission sections on the signal recording surfaces of the optical discs, and a hologram element arranged between the first through third emission sections and the objective lens, the hologram element having two major surfaces, wherein the hologram element is provided with a reference curved surface on one of the major surfaces thereof, the reference curved surface being an aspherical shape, and a hologram section is formed on the reference curved surface.

Thus, as a converging optical apparatus according to the invention includes a hologram element arranged between a light source section and an objective lens for converging light beams emitted from the light source section of three different respective wavelengths, and the hologram element is provided with a reference curved surface on one of the major surfaces thereof, the reference curved surface being an aspherical shape, and a hologram section is formed on the reference curved surface, it is now possible to realize compatibility with three different wavelengths and reduce the diffraction loss due to the hologram element in order to prevent the fall of the quantity of light of the light beam being converged on an optical disc. Thus, it is now possible to achieve excellent recording and reproduction performances.

### BRIEF DESCRIPTION OF THE DRAWINGS

FIG. 1 is a schematic block diagram of an embodiment of optical disc apparatus according to the invention;

FIG. 2 is a schematic illustration of the light paths of the optical system of an embodiment of optical pickup according to the invention;

FIG. 3 is a schematic cross sectional view of the hologram section of the hologram element of the embodiment of optical pickup of FIG. 2;

FIG. 4 is a schematic cross sectional view of the hologram section of the hologram element of the embodiment of optical pickup of FIG. 2 that is made to show a blaze-like profile;

FIG. 5 is a graph illustrating the relationship between the intensity of diffracted light of different degrees of diffraction of the light beams passing through the hologram section of the hologram element and the change in the phase depth;

FIG. 6 is a schematic illustration of the light paths of the optical system of another embodiment of optical pickup according to the invention;

FIG. 7 is a schematic cross sectional view of the objective lens of the embodiment of optical pickup of FIG. 6; and

FIGS. 8A through 8C illustrate the operation of an optical pickup according to the invention and the light beams passing through the optical pickup, FIG. 8A is a schematic cross sectional view of the optical pickup showing a light beam of the third wavelength, FIG. 8B is a schematic cross sectional view of the optical pickup showing a light beam of the second wavelength, and FIG. 8C is a schematic cross sectional view of the optical pickup showing a light beam of the first wavelength.

### DETAILED DESCRIPTION OF THE PREFERRED EMBODIMENTS

Now, the present invention will be described in greater detail by referring to the accompanying drawings that illustrate preferred embodiments of optical disc apparatus having an optical pickup according to the invention.

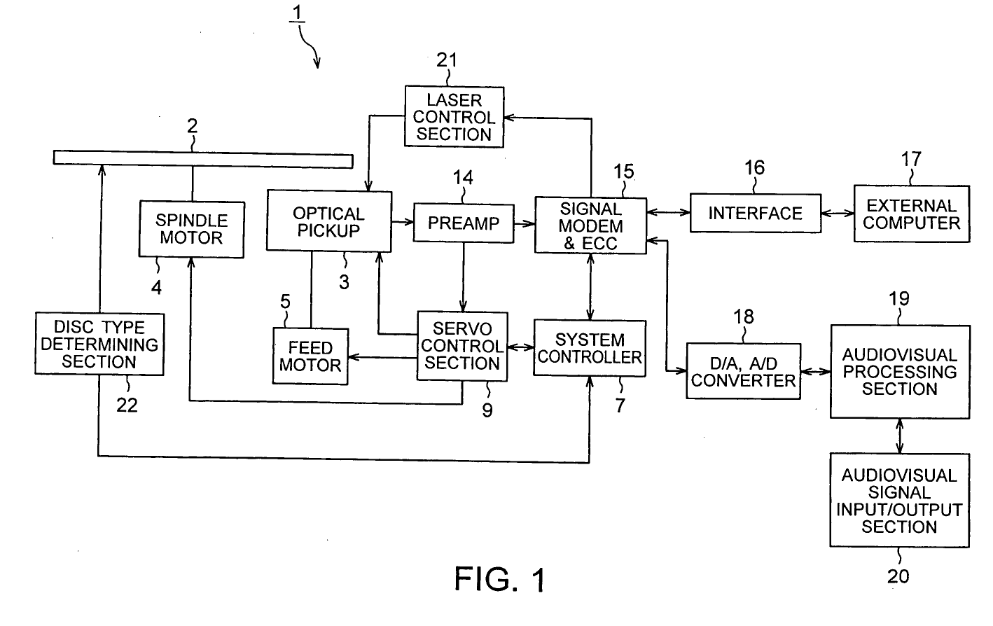

Referring to FIG. 1 that illustrates a schematic block diagram of an embodiment of optical disc apparatus according to the invention, the optical disc apparatus 1 includes an optical pickup 3 for recording information on and reproducing information from an optical disc 2, a spindle motor 4 that operates as drive means for driving the optical disc 2 to rotate and a feed motor 5 for moving the optical pickup 3 in a radial direction of the optical disc 2. The optical disc apparatus 1 is an inter-standard optical disc apparatus compatible with different standards so that it can record information on and/or reproduce information from an optical disc of any of three different types with three different formats and an optical disc having a multilayered recording layer.

Optical discs that can be used with the optical disc apparatus include optical discs such as CDs (compact discs), DVDs (digital versatile discs), CD-Rs (recordable CDs) and DVD-Rs (recordable DVDs) where information can be written, CD-RWs (rewritable CDs) and DVD-RWs (rewritable DVDs) where information can be rewritten and DVD+RWs (rewritable DVDs) as well as high density recording optical discs where information can be recorded highly densely by means of a semiconductor laser of a short emission wavelength of about 405 nm (blue-purple) and magneto-optical discs.

The embodiment of optical apparatus, or the optical disc 1, is adapted to be used with optical discs 2 of three different types for recording/reproducing information. Optical discs of three different types include optical discs 11 of the first type having a protection substrate of a thickness of 0.1 mm and adapted to high density recording, using a light beam of a wavelength of about 405 nm as recording/reproduction light beam, optical discs 12 of the second type such as DVDs having a protection substrate of a thickness of 0.6 mm and adapted to be used with a light beam of a wavelength of about 655 nm as recording/reproduction light beam and optical discs 13 of the third type such as CDs having a protection substrate of a thickness of 1.2 mm and adapted to be used with a light beam of a wavelength of about 780 nm as recording/reproduction light beam.

In the optical disc apparatus 1, the spindle motor 4 and the feed motor 5 are controlled by a servo control section 9 that is by turn controlled according to commands from a system controller 7 that operates as disc type determining means so as to operate differently depending on the type of disc. For instance, they are driven to rotate at a predetermined number of revolutions per unit time that is determined according to the type of disc they drive, which may be an optical disc 11 of the first type, an optical disc 12 of the second type or an optical disc 13 of the third type.

The optical pickup 3 has an optical system that is compatible with light beams of three different wavelengths and adapted to emit a light beam onto the recording layer of the optical disc of any of the three different standards mounted in the optical disc apparatus with a wavelength that varies depending on the optical disc and detect reflected light of the light beam reflected by the recording layer. The optical pickup 3 then supplies a signal that corresponds to the light beam to preamp section 14 according to the reflected light it detects.

The output of the preamp 14 is then fed to a signal modem and error correction code block (to be referred to as signal modification/demodulation & ECC block hereinafter) 15. The modification/demodulation & ECC block 15 modulates and demodulates signals and adds an ECC (error-correcting code) to signals. The optical pickup 3 irradiates the recording layer of the optical disc 2 that is being driven to rotate with a light beam according to the command from the signal modification/demodulation & ECC block 15 and records signals on or reproduces signals from the optical disc 2.

The preamp section 14 is adapted to generate a focus error signal, a tracking error signal, an RF signal and so on according to a signal that corresponds to the detected light beam that varies depending on the format of the optical disc. Thus, predetermined processing operations including those of demodulation and error correction are performed by the servo control section 9, the signal modification/demodulation & ECC block 15 and other related components according to the standard of the optical disc 2 that is the object medium for signal recording or signal reproduction.

If the recording signal demodulated by the signal modification/demodulation & ECC block 15 represents a data to be stored in a computer, it is transmitted to external computer 17 by way of interface 16. Thus, the external computer 17 can receive the signal recorded on the optical disc 2 as reproduced signal.

If the recording signal demodulated by the signal modification/demodulation & ECC block 15 represents an audiovisual data, it is subjected to digital/analog conversion in the D/A conversion section of the D/A and A/D converter 18 and supplied to audiovisual processing section 19. Then, the data is subjected to an audiovisual process in the audiovisual processing section 19 and transmitted to an external image pickup device or projector (not shown) by way of audiovisual signal input/output section 20.

The operation of the feed motor 5 and the spindle motor 4 and the spindle motor 4 for moving the optical pickup 3 to a predetermined recording track of the optical disc 2 and the operation of driving the biaxial actuator for holding the objective lens, which is the converging means of the optical pickup 3, in the focusing direction and the tracking direction are controlled by the servo control section 9.

The laser control section 21 controls the laser beam source of the optical pickup 3. Particularly, in this specific embodiment, the laser control section 21 controls the output power of the laser beam source so as to differentiate it between a recording mode and a reproduction mode. Additionally, the laser control section 21 controls the output power of the laser beam source depending on the type of the optical disc 2. The laser control section 21 switches the laser beam source of the optical pickup 3 depending on the type of the optical disc 2 detected by the disc type determining section 22.

The disc type determining section 22 can detect the format of the optical disc 2 according to the difference among optical discs 11, 12, 13 of the first through third types in terms of surface reflectivity, profile and appearance.

The blocks of the optical disc apparatus 1 are provided so as to be able to process signals according to the specifications of the optical disc 2 mounted in it by referring to the outcome of the detecting operation of the disc type determining section 22.

The system controller 7 determines the type of the optical disc 2 according to the outcome of the detecting operation of the disc type determining section 22. If the optical disc is of a type adapted to be contained in a cartridge, a typical technique of determining the type of optical disc is the use of a contact detection sensor or a depressible switch that operates through a detection hole bored through the cartridge. Techniques for detecting the recording layer to be used of an optical disc include one adapted to determine the recording layer to be used for recording or reproduction according to the TOC (table of contents) information recorded in pre-mastered pits or grooves arranged along the innermost track of the optical disc.

The servo control section 9 can determine the recording region to be used for recording and/or reproduction typically by detecting the position of the optical pickup 3 and that of the optical disc 2 relative to each other (including a process of detecting the relative positions according to the address signal recorded on the optical disc 2).

The optical disc apparatus 1 having the above described configuration drives the optical disc 2 to rotate by means of the spindle motor 4 and controls the driving operation of the feed motor 5 according to the control signal from the servo control section 9 so as to move the optical pickup 3 to a position corresponding to the desired recording track of the optical disc 2 and record information on or reproduce information from the optical disc 2.

Now, the above-described recording/reproduction optical pickup 3 will be described in greater detail below.

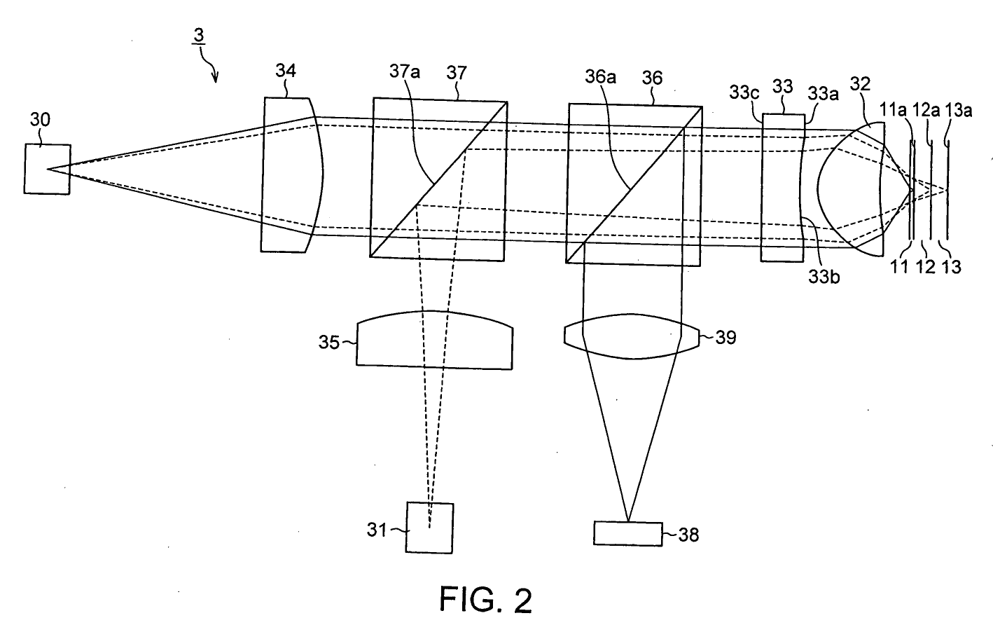

Referring to FIG. 2, the embodiment of optical pickup 3 includes a first light source section 30 having a first emission section for emitting a light beam of a first wavelength and a second emission section for emitting a light beam of a second wavelength, a second light source section 31 having a third emission section for emitting a light beam of a third wavelength, an objective lens 32 for converging the light beams emitted from the first through third emission section onto the signal recording surface of the optical disc 2, a hologram element 33 arranged between the first through third emission section and the objective lens 32, a first coupling lens 34 arranged between the first light source section 30 and the hologram element 33 and adapted to operate as angle of divergence changing means for changing the angle of divergence of the incident light beam, a second coupling lens 35 arranged between the second light source section 31 and the hologram element 33 and adapted to operate as angle of divergence changing means for changing the angle of divergence of the incident light beam, a first beam splitter 36 for forming a (backward) light path for the returning light beam reflected by the signal recording surface as a branch of the forward light path, a second beam splitter 37 that operates as light path synthesizing means for synthetically combining the light path of the light beam emitted from the first light source section 30 and the light path of the light beam emitted from the second light source section 31 and a photodetector 38 for receiving the returning light beam separated by the first beam splitter 36.

The first light source section 30 has a first emitting section for emitting a light beam of the first wavelength that is about 405 nm onto the first optical disc 11 and a second emitting section for emitting a light beam of the second wavelength that is about 655 nm onto the second optical disc 12. The second light source section 31 has a third emitting section for emitting a light beam of the third wavelength that is about 780 nm onto the third optical disc 13. While the first and second emitting sections and the third emitting section are made to belong to different respective light source sections in this embodiment, the present invention is by no means limited thereto and an optical pickup according to the invention may alternatively be so arranged as to include a light source section having the first and third emitting sections and a light source section having the second emitting section. While the light source section having two of the first through third emitting sections and the light source having the remaining emitting section are arranged at different respective positions in the above described embodiment, the present invention is by no means limited thereto and an optical pickup according to the invention may alternatively be so arranged as to includes light source sections having the first through third emitting sections located substantially at a same position or at different respective positions.

The objective lens 32 converges the incident light beam of one of the first through third wavelengths onto the signal recording surface of the optical disc 2. The objective lens 32 is movably held by an objective lens drive mechanism, which is typically a biaxial actuator (not shown). The objective lens 32 is driven for operation by the biaxial actuator according to the tracking error signal and the focusing error signal that are generated according to the RF signal of the returning light beam from the optical disc 2 as detected by the photodetector 38 so as to move in two axial directions including a direction along which it moves toward and away from the optical disc 2 and a radial direction of the optical disc 2. The objective lens 32 converges the light beam emitted from one of the first through third emitting sections constantly onto the signal recording surface of the optical disc 2 and, at the same time, causes the converged light beam to follow the recording track formed on the signal recording surface of the optical disc 2.

Besides, the objective lens 32 is so arranged as not to produce any aberration relative to the light beam of the first wavelength. It has a first surface S₁ located at the side for receiving the forwardly proceeding light beam and a second surface S₂ located near the optical disc. The first and second surfaces S₁, S₂ have an aspherical shape that is expressed by formula (1) below. Note that, in formula (1), r₁ represents the radius of curvature and x represents the distance from the optical axis, whereas A₁ through J₁ represent aspherical coefficients and Z₁ represents the distance from the plane orthogonally intersecting the optical axis and adapted to operate as reference at the position separated from the optical axis by distance x as measured in the direction of the optical axis.

$${Z}_{i} = \frac{{r}_{1}^{- 1} {x}^{2}}{1 + \sqrt{1 - ( 1 + {k}_{1} ) {r}_{1}^{- 2} {x}^{2}}} + {A}_{1} {x}^{4} + {B}_{1} {x}^{6} + {C}_{1} {x}^{8} + {D}_{1} {x}^{10} + {E}_{1} {x}^{12} + {F}_{1} {x}^{14} + {G}_{1} {x}^{16} + {H}_{1} {x}^{18} + {J}_{1} {x}^{20} \qquad ( 1 )$$

The objective lens 32 is adapted to converge the light beam of the first wavelength entering it as collimated light onto the signal recording surface of the first optical disc 11. The objective lens 32 converges the light beam of the second wavelength entering it with a predetermined angle of divergence onto the signal recording surface of the second optical disc 12 and also converges the light beam of the third wavelength entering it with a predetermined angle of divergence onto the signal recording surface of the third optical disc 13.

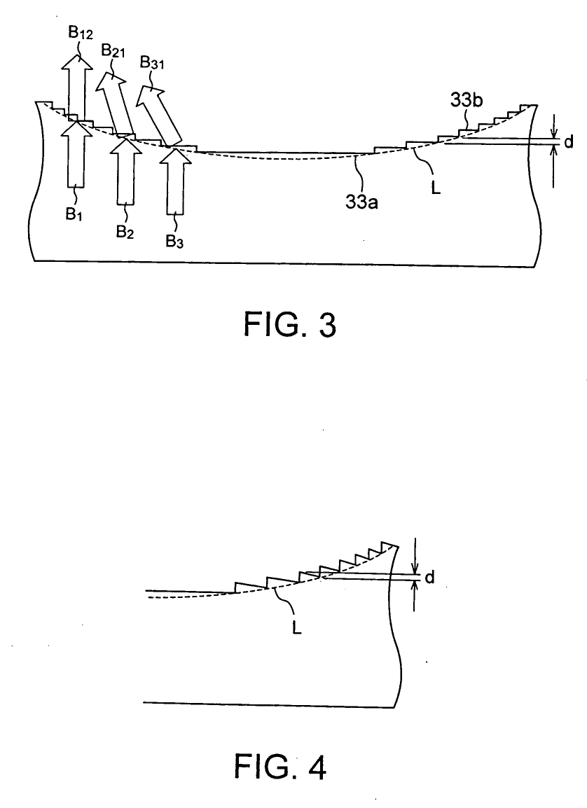

The hologram element 33 is made of a glass material and, as shown in FIGS. 2 and 3, provided on one of the two surfaces thereof that is located close to the objective lens 32 with a recess 33a that shows an aspherical shape and operates as reference curved surface and the hologram section 33b is formed on the recess 33a. The hologram section 33b is made of an acrylic resin material that can be machined directly or molded in a mold. For example, it may be formed by replica molding of an acryl type resin material on the reference curved surface of the recess 33a of the hologram element 33.

While the hologram section 33b is formed by replica molding of an acryl type UV-curved resin on the recess 33a that shows an aspherical shape and operates as reference curved surface of the hologram element 33 that is made of a glass material in this embodiment, the present invention is by no means limited thereto and the hologram section may be integrally formed with the hologram element by using an acryl type resin such as ZEONEX (tradename) or directly machined.

The other surface of the hologram element 33 that is located closer to the forwardly proceeding light beam entering side thereof is provided with an aperture limiting means 33c for limiting the aperture in order to make the numerical aperture for the passing light beam match the format of the optical disc 2.

The reference curved surface of the hologram section 33b is expressed by formula (2) shown below. Note that, in formula (2), c represents the radius of curvature and k represents the cone coefficient, whereas A through D represents the aspherical coefficients and x and Z(x) respectively represent the distance from the optical axis and the sag of the aspherical surface or the distance from the plane orthogonally intersecting the optical axis and adapted to operate as reference at the position separated from the optical axis by distance x as measured in the direction of the optical axis.

$$Z ( x ) = \frac{{cx}^{2}}{1 + \sqrt{1 - ( 1 + k ) {c}^{2} {x}^{2}}} + {Ax}^{4} + {Bx}^{6} + {Cx}^{8} + {Dx}^{10} \qquad ( 2 )$$

The hologram section 33b that is formed on the reference curved surface is made to have continuously arranged step sections and show a staircase-like profile and each of the step sections is made to show a depth of d that is determined by formula (3) below. Note that, in formula (3), d represents the depth of each of the step sections of the hologram section and m represents the degree of diffraction (m-th degree) of diffracted light, whereas λ represents the wavelength of the incident light beam and N represents the refractive index of the acryl type resin material of the hologram section 33b.
d=mλ/(N−1) (3)

In formula (3) above, d is determined by m=2, N=1.543 and λ=0.405. Thus, the depth d is d=2×0.405/(1.543−1)=1.492(μm).

The light path difference produced by the hologram section 33b formed on the reference curved surface is expressed by formula (4) below. Note that, in formula (4), C₁ through C₄ represent hologram coefficients and x represents the distance from the optical axis, whereas P(x) represents the light path difference at the position separated from the optical axis by x.
P(x)=C₁x²+C₂x⁴+C₃x⁶+C₄x⁸+C₅x¹⁰ (4)

For the reference curved surface and the hologram section 33b of the hologram element 33, the coefficients k, A through D and C₁ through C₄ of the above formulas (1) and (2) are expressed respectively by the formulas (5) below.

$$k = - 1 \\ {C}_{1} = - \frac{N - 1}{m} \frac{c}{2} \\ {C}_{2} = - \frac{N - 1}{m} A \\ {C}_{3} = - \frac{N - 1}{m} B \\ {C}_{4} = - \frac{N - 1}{m} C \\ {C}_{5} = - \frac{N - 1}{m} D \qquad ( 5 )$$

The light beams of the first through third wavelengths that pass through the hologram section 33b of the hologram element 33 having the above-described configuration are turned into light beams of different degrees of diffraction by the hologram section 33b. More specifically, the light beam of the first wavelength is made to show a quantity of diffracted light of the second degree substantially equal to 100% and the light beams of the second and third wavelengths are made to show a quantity of diffracted light of the first degree not smaller than 96%.

As shown in FIG. 3, the hologram section 33b of the hologram element 33 emits the diffracted light B₁₂ of the second degree of the light beam B₁ of the first wavelength that enters it as collimated light also as collimated light, whereas it emits the diffracted lights B₂₁ and B₃₁ of the first degree of the light beams B₂, B₃ of the second and third wavelengths that enter it as collimated light as divergent light.

As for the diffracted light of the second degree of the light beam of the first wavelength, its diffraction angle attributable to the hologram section 33b and the refraction angle of the aspherical reference curved surface are offset by each other so that it is emitted toward the objective lens 32 as collimated light.

The hologram section 33b corrects the aberration of the light beams of the second and third wavelengths by means of the objective lens 32 that is adapted not to generate any aberration to the light beam of the first wavelength as described above. In other words, the hologram section 33b can nullify the aberration that arises on the signal recording surface of the optical disc 2 by providing the light beams of the second and third wavelengths with aberration that offsets the aberration generated by the objective lens 32 before they enter the objective lens 32.

Since the hologram section 33b is formed on the aspherical reference curved surface of the hologram element 33, it can be produced with ease by machining or molding if compared with known hologram elements that require a plurality of processing steps. In short, the efficiency of forming the hologram element 33 is improved.

While the hologram section shows a staircase-like profile with step sections of a predetermined depth d that is determined in a manner as described above in this embodiment the present invention is by no means limited thereto and it may alternatively show a blaze-like profile as illustrated in FIG. 4.

While the aspherical recess 33a that operates as reference curved surface is arranged on the light emitting side of the hologram element 33 that is located closer to the objective lens 32 and the hologram section 33b is arranged on the recess 33a in this embodiment, the present invention is by no means limited thereto. Alternatively, for example, the aspherical reference curved surface may be arranged on the light receiving side of the hologram element 33 and the hologram section 33b may be arranged on the reference curved surface. Still alternatively, the aspherical reference curved surface may be made to show a protruded profile and the hologram section may be formed on the aspherical protrusion that operates as reference curved surface.

The first coupling lens 34 changes the angle of divergence of the light beam of the first or second wavelength emitted from the first light source section 30 and substantially collimates the light beam before it emits the light beam toward the second beam splitter 37.

The second coupling lens 35 changes the angle of divergence of the light beam of the third wavelength emitted from the second light source section 31 and emits it toward the second beam splitter 37.

The first beam splitter 36 is arranged on the light path between the first coupling lens 34 and the second coupling lens 35 and the hologram element 33 and forms a (backward) light path for the returning light beam from the optical disc 2 as a branch of the forward light path by means of a mirror surface 36a thereof and emits the returning light beam. An optical element 39 that is typically a cylinder lens for converging the laser beam of the branch light path onto the light receiving surface of the photodetector 38 is arranged between the first beam splitter 36 and the photodetector 38.

The second beam splitter 37 is arranged on the light path between the first coupling lens 34 and the second coupling lens 35 and the first beam splitter 36 and has a mirror surface 37a that shows wavelength selectivity. The mirror surface 37a transmits the light beam emitted from the first emission section and the light beam emitted from the second emission section of the first light source section 30 and reflects the light beam emitted from the third emission section of the second light source section 31 so as to synthetically combine the light paths of the light beams emitted from the first through third emission sections.

The optical pickup 3 having the above-described configuration drives the objective lens 32 to move it to the focusing position relative to the signal recording surface of the optical disc 2 according to the focusing error signal and the tracking error signal obtained by the photodetector 38. Thus, the light beam is focused onto the signal recording surface of the optical disc 2 and information is recorded on or reproduced from the optical disc 2.

Thus, the optical pickup 3 can read signals from and write signals on any of the optical discs 11, 12, 13 of a plurality of different types by means of the corresponding one of the light beams having different wavelengths and emitted from the plurality of emission sections of the first and second light source sections 30, 31 by achieving an optimum diffraction efficiency and an optimum diffraction angle by means of the hologram element 33.

The objective lens 32 and the hologram element 33 of the above-described optical pickup 3 operate as converging optical apparatus for converging the entering light beam onto a predetermined position. In the converging optical apparatus, the hologram element 33 is arranged at the light receiving side of the objective lens 32 and provided on one of the two surfaces thereof that operates as aspherical reference curved surface with the hologram section 33b. With this arrangement, the converging optical apparatus is compatible with light beams of three different wavelengths and at the same time prevents any fall of the quantity of light of the light beam being converged by reducing the diffraction loss attributable to the hologram element.

Now, the principle of the operation of signal recording/reproduction of the optical pickup 3 on any of the first through third optical discs 11, 12, 13 and hence that of achieving the compatibility relative to different formats of the hologram element 33 will be discussed below.

As described above, the optical pickup 3 can adapt itself to optical discs of three different types only by means of the hologram section formed on one of the two surfaces of the hologram element 33. The optical pickup 3 uses diffracted light of the second degree for the light beam of the first wavelength of about 405 nm that corresponds to the first optical disc 11 but uses diffracted light of the first degree both for the light beam of the second wavelength of about 660 nm that corresponds to the second optical disc 12 and for the light beam of the third wavelength of about 780 nm that corresponds to the third optical disc 13.

FIG. 3 shows the recess 33a of the hologram element 33 for forming the hologram section 33b and the profile of the hologram section 33b formed on the recess 33a. Referring to FIG. 3, broken line L indicates the aspherical reference curved surface of the recess 33a for defining the profile of the hologram section 33b.

As shown in FIG. 3, the hologram section 33b is formed to have continuously arranged step sections and show a staircase-like profile. The depths of the step sections as viewed in the direction of the optical axis are made to equal to each other. More specifically, they are made to be equal to integer times of the phase difference of the first wavelength (405 nm). The depth of the step sections is defined according to the degree of diffracted light (diffracted light of what degree) to be used.

The depth d of each of the step sections (a step) of the staircase-like profile of the hologram section 33b is determined by the above-described formula (3). Note that, in formula (3), d represents the depth of each of the step sections of the hologram section and m represents the degree of diffraction (m-th degree) of diffracted light, whereas λ represents the wavelength of the incident light beam and N represents the refractive index of the acryl type resin material of the hologram section 33b.

Since diffracted light of the second degree is used for the light beam of the first wavelength here, the coefficients of the formula (3) are expressed by the formulas (6) shown below.
m=2
N=1.543
λ=0.405 (6)

From the formulas (3) and (6), the depth d is d=2×0.405/(1.543−1)=1.492 (μm).

The ratio of the quantity of diffracted light relative to the quantity of light of the light beam of the first wavelength (405 nm) entering the hologram section having the above described configuration is theoretically 100% except the loss due to reflection and absorption.

Now, the relationship between the aspherical reference curved surface and the profile of the hologram section 33b will be discussed below.

The diffraction angle of the light beam passing through the hologram section 33b is determined by the pitch of the grating, or the intra-planar pitch of the step sections of the staircase as viewed in a plane orthogonally intersecting the optical axis. The quantity of light of the light beam passing through the hologram section is determined as a function of the depth of the grating, or the depth d of each of the step section of the staircase as viewed in the direction of the optical axis. As the hologram section 33 is formed so as to make the diffraction angle determined by the pitch of the step sections offset and cancel the refraction angle determined by the aspherical shape of the reference curved surface, diffracted light of the second degree of the light beam of the first wavelength is emitted from the hologram section 33 to proceed straight ahead, or as collimated light.

As the hologram section 33b is formed in a manner as described above, an objective lens 33 originally designed for the first wavelength is used. In other words, the objective lens 33 is designed so as not go give rise to any aberration when it converges the light beam of the first wavelength onto the signal recording surface of the first optical disc 11.

On the other hand, both the light beam of the second wavelength and the light beam of the third wavelength are diffracted by the hologram section 33b but the aspherical shape of the hologram element 33 is optimized so as to correct both the spherical aberration generated due to the relationship between the thickness of the second optical disc 12 and the wavelength and the spherical aberration generated due to the relationship between the thickness of the third optical disc 13 and the wavelength by the diffraction angle and the refraction angle produced by the aspherical reference curved surface. In other words, the shape of the aspherical surface is designed to correct the spherical aberrations.

As pointed out above, the light beam of the first wavelength proceeds straight ahead through the hologram section 33b. In other words, it enters the hologram section as collimated light and emitted from it as collimated light. Thus, the phase difference and the aspherical shape of the hologram section 33b show the relationship as described below.

The aspherical surface of the reference curved surface of the hologram section 33b of the hologram element 33 is defined by the above described formula (2). On the other hand, the light path difference produced by the hologram section 33b is defined by the above-described formula (4).

Therefore, for the diffraction angle due to the hologram section 33b to offset the refraction angle due to the aspherical reference curved surface for diffracted light of the m-th degree that passes through the hologram element 33 having the hologram section 33b, it is necessary to meet the requirement of the relationship defined by formula (7) below. Note that, in formula (7), N represents the refractive index of the acryl type resin of the hologram section 33b and m represents the degree of diffraction.

$$Total = Z ( x ) + m \frac{P ( x )}{N - 1} = 0 \qquad ( 7 )$$

The requirement of the relationship of the above described formula (7) is met when the profile of the hologram section 33b is defined in such a way that the coefficients k, A through D and C₁ through C₄ satisfy the respective relationships of the above described formulas (5).

When the hologram section 33b is formed to show a staircase-like profile with the depth of the step sections of the hologram section 33b equal to d as defined by the above-described formula (3), the light beam of the first wavelength proceeds straight ahead and the aberration of the light beam of the second wavelength and that of the light beam of the third wavelength are corrected. Note that, in the above described formula (3), d represents the depth of each of the step sections of the hologram section and m represents the degree of diffraction (m-th degree) of diffracted light, whereas λ represents the wavelength of the incident light beam and N represents the refractive index of the acryl type resin material of the hologram section 33b.

Now, the reason why diffracted light of the second degree is used for the light beam of the first wavelength and diffracted light of the first degree is used of the light beam of the second wavelength and that of the third wavelength will be described below.

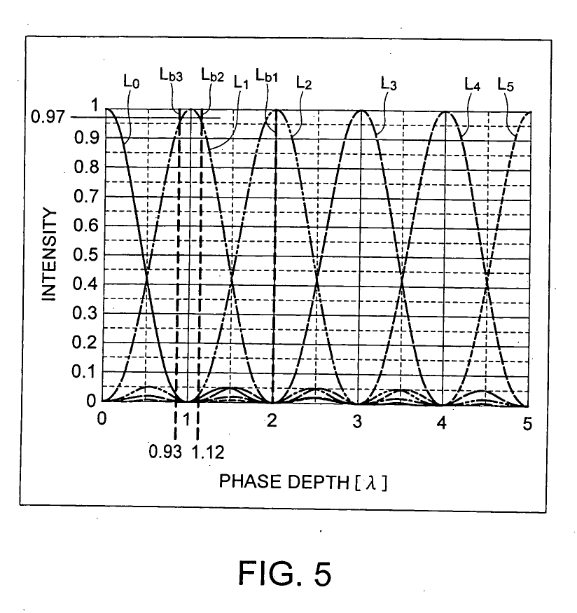

FIG. 5 is a graph illustrating the relationship between the intensity of diffracted light, or the quantity of diffracted light, of different degrees of diffraction of the light beams passing through the hologram section of the hologram element 33 and the change in the phase depth P(x). In other words, FIG. 5 illustrates the diffraction efficiency of the hologram element 33. In FIG. 5, the solid line L₀ indicates the change in the intensity relative to the phase depth of diffracted light of the 0-th degree and the dotted chain line L₁ indicates the change in the intensity relative to the phase depth of diffracted light of the first degree, whereas the double dotted chain line L₂ indicates the change in the intensity relative to the phase depth of diffracted light of the second degree and the broken lines L₃, L₄ and L₅ respectively indicate the changes in the intensity relative to the phase depths of diffracted light of the third, fourth and fifth degrees.

In FIG. 5, the broken lines L_{b1}, L_{b2} and L_{b3} are drawn to determine the intensities of the light beams of the first through third wavelengths. More specifically, when the intensity of diffracted light of the second degree of the light beam of the first wavelength (405 nm) is highest and hence the phase depth is 2λ as indicated by the broken line L_{b1}, the phase depth of the light beam of the second wavelength (660 nm) is 1.12λ and diffracted light of the first degree is diffracted by not less than 96% as indicated by the broken line L_{b2} and the phase depth of the light beam of the third wavelength (780 nm) is 0.93λ and diffracted light of the first degree is diffracted by not less than 97% as indicated by the broken line L_{b3}. Thus, it is possible to achieve a very high efficiency for the user of light and obtain a sufficient quantity of light for both recording and reproduction of signals with light beams of the three different types (light beams of the first through third wavelengths).

The phase depth of the light beam of the second wavelength and that of the light beam of the third wavelength are computed by means of formula (8) shown below. Note that, in formula (8), d represents the depth; which is equal to 1.492 (μm) from the above formulas (3) and (6) and Nw represents the refractive index of the hologram section 33b, which is equal to 1.497 relative to the light beam of the second wavelength (660 nm) and 1.544 relative to the light beam of the third wavelength (780 nm), whereas λ represents the wavelength of the incident light beam.
P=d×(Nw−1)/λ (8)

Now, the light paths of the light beams emitted from the first and second light source sections 30, 31 of the above-described optical pickup 3 will be described below by referring to FIG. 2. Firstly, the light path of the light beam of the first wavelength that is emitted onto the first optical disc 11 to read or write information will be described.

As the disc type determining section 22 determines that the type of the optical disc 2 is that of the first disc 11, it causes the first emission section of the first light source section 30 to emit a light beam of the first wavelength.

The light beam of the first wavelength emitted from the first emission section of the first light source section 30 is changed for its angle of divergence by the first coupling lens 34 and turned into a substantially collimated light beam before it is emitted toward the second beam splitter 37. The light beam of the first wavelength that is collimated by the first coupling lens 34 is transmitted through the mirror surface 37a of the second beam splitter 37 and also through the mirror surface 36a of the first beam splitter 36 and enters the hologram element 33.

The light beam of the first wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the first wavelength is made to show a quantity of light substantially equal to 100% for diffracted light of the second degree by the hologram section 33b and the diffraction angle due to the hologram section 33b offsets the refraction angle due to the aspherical reference curved surface so that the light beam of the first wavelength is emitted as collimated light.

Diffracted light of the second degree of the light beam of the first wavelength that is diffracted by the hologram element 33 is properly converged onto the signal recording surface 11a of the first optical disc 11 by the objective lens 32.

The light beam converged onto the first optical disc 11 is reflected by the signal recording surface and passes through the objective lens 32 and the hologram element 33 before it is reflected by the mirror surface 36a of the first beam splitter 36 and emitted toward the photodetector 38. The light beam branched by the first beam splitter 36 is then converged on the light receiving surface of the photodetector 38 and detected by the optical element 39.

Now, the light path of the light beam of the second wavelength that is emitted onto the second optical disc 12 to read or write information will be described.

As the disc type determining section 22 determines that the type of the optical disc 2 is that of the second disc 12, it causes the second emission section of the first light source section 30 to emit a light beam of the second wavelength.

The light beam of the second wavelength emitted from the second emission section of the first light source section 30 is changed for its angle of divergence by the first coupling lens 34 and turned into a substantially collimated light beam before it is emitted toward the second beam splitter 37. The light beam of the second wavelength that is collimated by the first coupling lens 34 is transmitted through the mirror surface 37a of the second beam splitter 37 and also through the mirror surface 36a of the first beam splitter 36 and enters the hologram element 33.

The light beam of the second wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the second wavelength is made to show a quantity of light substantially equal to 96% for diffracted light of the first degree by the hologram section 33b and the aberration that is generated when the light beam passes through the objective lens is corrected and emitted as divergent light as will be described hereinafter in greater detail.

Diffracted light of the first degree of the light beam of the of the second wavelength that is diffracted by the hologram element 33 is properly converged onto the signal recording surface 12a of the second optical disc 12 by the objective lens 32.

The return light path of the light beam reflected by the signal recording surface 12a of the second optical disc 12 is same as the above described one of the light beam of the first wavelength and hence will not be described here any further.

Now, the light path of the light beam of the third wavelength that is emitted onto the third optical disc 13 to read or write information will be described.

As the disc type determining section 22 determines that the type of the optical disc 2 is that of the third disc 13, it causes the third emission section of the second light source section 31 to emit a light beam of the third wavelength.

The light beam of the third wavelength emitted from the third emission section of the second light source section 31 is changed for its angle of divergence by the second coupling lens 35 and emitted toward the second beam splitter 37. The light beam of the third wavelength that is changed for the angle of divergence by the second coupling lens 35 is reflected by the mirror surface 37a of the second beam splitter 37 and its light path is shifted and then synthetically combined with the above described light paths of the light beams of the first and second wavelengths. The light beam of the third wavelength reflected by the mirror surface 37a of the second beam splitter 37 is transmitted through the mirror surface 36a of the first beam splitter 36 and enters the hologram element 33.

The light beam of the third wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the third wavelength is made to show a quantity of light substantially equal to 96% for diffracted light of the first degree by the hologram section 33b and the aberration that is generated when the light beam passes through the objective lens is corrected and emitted as divergent light as will be described hereinafter in greater detail.

Diffracted light of the first degree of the light beam of the third wavelength that is diffracted by the hologram element 33 is properly converged onto the signal recording surface 13a of the third optical disc 13 by the objective lens 32.

The return light path of the light beam reflected by the signal recording surface 13a of the third optical disc 13 is same as the above described one of the light beam of the first wavelength and hence will not be described here any further.

While the light beam of the third wavelength is changed for the angle of divergence by the second coupling lens 35 in this embodiment, the present invention is by no means limited thereto. Alternatively, it may be so arranged that the light beam of the third wavelength is made to enter the hologram element 33 by way of the second beam splitter 37 and the first beam splitter 36 without being changed for the angle of divergence by adjusting the positional arrangement of the third emission section.

Additionally, while the light beams of the first and second wavelengths are substantially collimated by the first coupling lens 34, while the light beam of the third wavelength is turned to divergent light by the second coupling lens 35 before entering the hologram element 33 in this embodiment, the present invention is by no means limited thereto. Alternatively, for example, it may be so arranged that all the light beams of the first through third wavelengths are collimated or some or all of the light beams of the first through third wavelengths are turned to divergent light or convergent light before entering the hologram element.

The embodiment of optical pickup 3 according to the present invention is provided with a hologram element 33 between the first and second light source sections 30, 31 and the objective lens 32 for converging the light beams of the three different types emitted from the first through third emission sections arranged in the first and second light source sections 30, 31 and a hologram section 33b is formed on the recess 33a at one of the two surfaces of the hologram element 33, the recess 33a having an aspherical reference curved surface, in order to make the optical pickup 3 compatible with three wavelengths and prevent any fall of the quantity of light of the light beam being converged on the optical disc by reducing the diffraction loss attributable to the hologram element 33. Thus, the embodiment of optical pickup can adapt itself to not only signal reproduction but also to signal recording with ease to realize excellent recording/reproduction characteristics.

Thus, the above described embodiment of optical pickup 3 according to the present invention can bring forth an optimal diffraction efficiency and an optimal diffraction angle by means of a single hologram element so that it can read signals from and write signals on any of the optical discs 11, 12, 13 of different types by means of the matching light beam selected from the light beams of different wavelengths emitted from the plurality of emission sections arranged in the first and second light source sections 30, 31. Additionally, it commonly uses optical parts such as the objective lens for all the optical discs to make it possible to simplify the configuration of and downsize the optical pickup. Thus, the present invention can achieve high productivity and low cost.

Additionally, the above described embodiment of optical pickup 3 according to the present invention can bring forth an optimal diffraction efficiency and an optimal diffraction angle for light beams of a plurality of different wavelengths by means of a single hologram element so that it can commonly use optical parts such as the objective lens for all the optical discs to make it possible to simplify the configuration of and downsize the optical pickup. Thus, the present invention can achieve high productivity and low cost.

Still additionally, in the above described embodiment of optical pickup 3 according to the present invention, the hologram element 33 is provided on the aspherical reference curved surface thereof with a hologram section 33b, the hologram element 33 can be processed with an improved efficiency if compared with conventional hologram elements having a hologram profile that requires a plurality of steps for preparation. Thus, the above-described embodiment of optical pickup 3 can further improve the productivity and reduce the manufacturing cost.

While the first and second emission sections are arranged in the first light source section 30 and the third emission section is arranged in the second light source section 31 in the above described embodiment of optical pickup 3, the present invention is by no means limited thereto and, for example, all the first through third emission sections may alternatively be arranged in a single light source section.

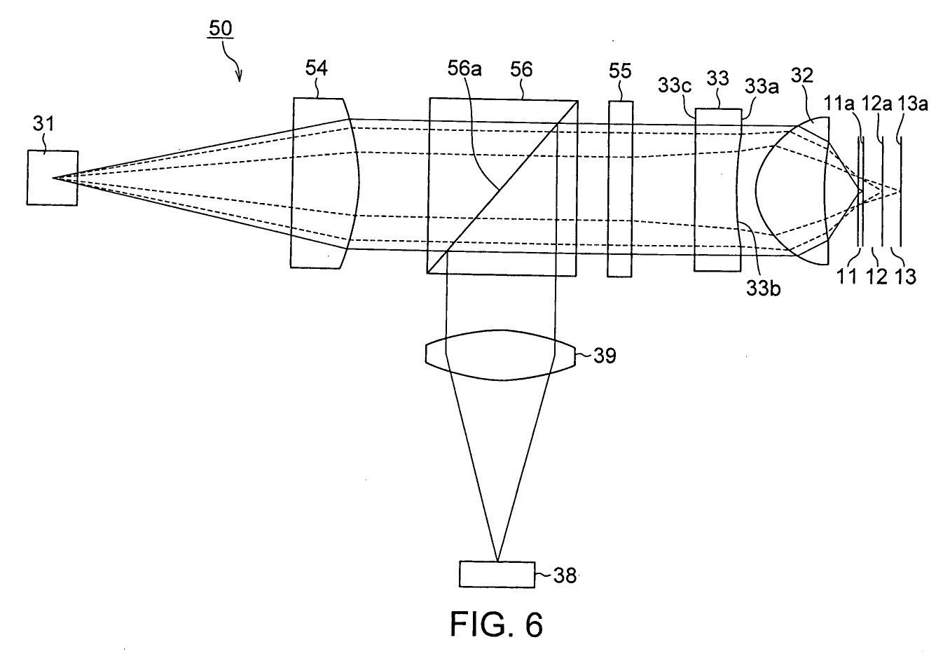

Now an embodiment of optical pickup 50 including a single light source section having first through third emission sections will be described below by referring to FIG. 6. In the following description, the components that are common to the above-described embodiment of optical pickup 3 are denoted respectively by the same reference symbols and will not be described in detail.

As shown in FIG. 6, the optical pickup 50 includes a light source section 51 having first through third emission sections and adapted to emit a plurality of light beams of different wavelengths, an objective lens 32 for converging the light beams emitted from the light source section 51 onto the signal recording surface of the optical disc 2, a hologram element 33 arranged between the light source section 51 and the objective lens 32, a coupling lens 54 arranged between the light source section 51 and the hologram element 33 and adapted to operate as angle of divergence changing means for changing the angle of divergence of the incident light beam, a beam splitter 56 for forming a (backward) light path for the returning light beam reflected by the signal recording surface as a branch of the forward light path and a photodetector 38 for receiving the returning light beam separated by the first beam splitter 56.

The optical pickup 50 additionally includes a diffraction element 55 arranged between the beam splitter 56 and the hologram element 33 to operate as selective angle of divergence changing means for changing the angle of divergence of the incident light beam depending on the wavelength thereof.

The light source section 51 has a first emitting section for emitting a light beam of the first wavelength that is about 405 nm onto the first optical disc 11, a second emitting section for emitting a light beam of the second wavelength that is about 655 nm onto the second optical disc 12 and a third emitting section for emitting a light beam of the third wavelength that is about 780 nm onto the third optical disc 13.

The coupling lens 54 changes the angle of divergence of the light beam of any of the first through third wavelengths emitted from the light source section 51 and substantially collimates the light beam before it emits the light beam toward the beam splitter 56.

The beam splitter 56 is arranged on the light path between the coupling lens 54 and the hologram element 33 and, like the first beam splitter 36 of the above described embodiment, forms a (backward) light path for the returning light beam from the optical disc 2 as a branch of the forward light path by means of a mirror surface 56a thereof and emits the returning light beam. An optical element 39 that is typically a cylinder lens for converging the laser beam of the branch light path onto the light receiving surface of the photodetector 38 is arranged between the beam splitter 56 and the photodetector 38.

The diffraction element 55 transmits the light beams of the first and second wavelengths and diffracts the light beam of the third wavelength. In other words, it selectively changes the angle of divergence of the light beam of the third wavelength. Thus, the diffraction element 55 transmits the light beams of the first and second wavelengths that enter it as collimated light also as collimated light but diffracts the light beam of the third wavelength that enters it as collimated light and emits it as divergent light.

The optical pickup 50 having the above described configuration drives the objective lens 32 to move it to the focusing position relative to the signal recording surface of the optical disc 2 according to the focusing error signal and the tracking error signal obtained by the photodetector 38. Thus, the light beam is focused onto the signal recording surface of the optical disc 2 and information is recorded on or reproduced from the optical disc 2.

Thus, the optical pickup 50 can read signals from and write signals on any of the optical discs 11, 12, 13 of a plurality of different types by means of the corresponding one of the light beams having different wavelengths and emitted from the plurality of emission sections of the light source section 51 by achieving an optimum diffraction efficiency and an optimum diffraction angle by means of the hologram element 33.

The objective lens 32 and the hologram element 33 of the above-described optical pickup 50 operate as converging optical apparatus for converging the entering light beam onto a predetermined position. In the converging optical apparatus, the hologram element 33 is arranged at the light receiving side of the objective lens 32 and provided on one of the two surfaces thereof that operates as aspherical reference curved surface with the hologram section 33b. With this arrangement, the converging optical apparatus is compatible with light beams of three different wavelengths and at the same time prevents any fall of the quantity of light of the light beam being converged by reducing the diffraction loss attributable to the hologram element.

Since the principle of the operation of signal recording/reproduction of the optical pickup 50 on any of the first through third optical discs 11, 12, 13 and hence that of achieving the compatibility relative to different formats of the hologram element 33 are same as those of the above described optical pickup 3 and hence will not be described here any further.

Now, the light paths of the light beams emitted from the light source section 51 of the above described optical pickup 50 will be described below by referring to FIG. 6. Firstly, the light path of the light beam of the first wavelength that is emitted onto the first optical disc 11 to read or write information will be described.

As the disc type determining section 22 determines that the type of the optical disc 2 is that of the first disc 11, it causes the first emission section of the light source section 51 to emit a light beam of the first wavelength.

The light beam of the first wavelength emitted from the first emission section of the light source section 51 is changed for its angle of divergence by the coupling lens 54 and turned into a substantially collimated light beam before it is emitted toward the beam splitter 56. The light beam of the first wavelength that is collimated by the coupling lens 54 is transmitted through the mirror surface 56a of the beam splitter 56 and through the diffraction element 55 and enters the hologram element 33.

The light beam of the first wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the first wavelength is made to show a quantity of light substantially equal to 100% for diffracted light of the second degree by the hologram section 33b and the diffraction angle due to the hologram section 33b offsets the refraction angle due to the aspherical reference curved surface so that the light beam of the first wavelength is emitted as collimated light.

Diffracted light of the second degree of the light beam of the first wavelength that is diffracted by the hologram element 33 is properly converged onto the signal recording surface 11a of the first optical disc 11 by the objective lens 32.

The light beam converged onto the first optical disc 11 is reflected by the signal recording surface and passes through the objective lens 32, the hologram element 33 and the diffraction element 55 before it is reflected by the mirror surface 56a of the beam splitter 56 and emitted toward the photodetector 38. The light beam branched by the beam splitter 56 is then converged on the light receiving surface of the photodetector 38 and detected by the optical element 39.

Now, the light path of the light beam of the second wavelength that is emitted onto the second optical disc 12 to read or write information will be described.

As the disc type determining section 22 determines that the type of the optical disc 2 is that of the second disc 12, it causes the second emission section of the light source section 51 to emit a light beam of the second wavelength.

The light beam of the second wavelength emitted from the second emission section of the light source section 51 is changed for its angle of divergence by the coupling lens 54 and turned into a substantially collimated light beam before it is emitted toward the beam splitter 56. The light beam of the second wavelength that is collimated by the coupling lens 54 is transmitted through the mirror surface 56a of the second beam splitter 56 and the diffraction element 55 and enters the hologram element 33.

The light beam of the second wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the second wavelength is made to show a quantity of light substantially equal to 96% for diffracted light of the first degree by the hologram section 33b and the aberration that is generated when the light beam passes through the objective lens is corrected and emitted as divergent light as will be described hereinafter in greater detail.

Diffracted light of the first degree of the light beam of the of the second wavelength that is diffracted by the hologram element 33 is properly converged onto the signal recording surface 12a of the second optical disc 12 by the objective lens 32.

The return light path of the light beam reflected by the signal recording surface 12a of the second optical disc 12 is same as the above described one of the light beam of the first wavelength and hence will not be described here any further.

Now, the light path of the light beam of the third wavelength that is emitted onto the third optical disc 13 to read or write information will be described.

As the disc type determining section 22 determines that the type of the optical disc 2 is that of the third disc 13, it causes the third emission section of the light source section 51 to emit a light beam of the third wavelength.

The light beam of the third wavelength emitted from the third emission section of the light source section 51 is changed for its angle of divergence by the coupling lens 54 and emitted toward the beam splitter 56. The light beam of the third wavelength that is collimated by the coupling lens 54 is then transmitted through the mirror surface 56a of the beam splitter 56 and diffracted and changed for the angle of divergence by the diffraction element 55 before it enters the hologram element 33.

The light beam of the third wavelength that enters the hologram element 33 is limited for the aperture by the aperture limiting means 33c arranged at the other surface of the hologram element 33 and diffracted by the hologram section 33b arranged at the surface through which the light beam enters the hologram element 33. At this time, diffracted light of the light beam of the third wavelength is made to show a quantity of light substantially equal to 96% for diffracted light of the first degree by the hologram section 33b and the aberration that is generated when the light beam passes through the objective lens is corrected and emitted as divergent light as will be described hereinafter in greater detail.

Diffracted light of the first degree of the light beam of the of the third wavelength that is diffracted by the hologram element 33 is properly converged onto the signal recording surface 13a of the third optical disc 13 by the objective lens 32.

The return light path of the light beam reflected by the signal recording surface 13a of the third optical disc 13 is same as the above described one of the light beam of the first wavelength and hence will not be described here any further.

While all the light beams of the first through third wavelengths are substantially collimated by the coupling lens 54 and only the light beam of the third wavelength is turned to divergent light by the diffraction element 55 before they enter the hologram element 33, the present invention is by no means limited thereto. For example, after collimating all the light beams of the first through third wavelengths, any or all of the light beams of the first through third wavelength may be turned to divergent light or convergent light before the light beams of the first through third wavelength enter the hologram element.

The embodiment of optical pickup 50 according to the present invention is provided with a hologram element 33 between the light source section 51 and the objective lens 32 for converging the light beams of the three different types emitted from the first through third emission sections arranged in the light source sections 51 and a hologram section 33b is formed on the recess 33a at one of the two surfaces of the hologram element 33, the recess 33a having an aspherical reference curved surface, in order to make the optical pickup 50 compatible with three wavelengths and prevent any fall of the quantity of light of the light beam being converged on the optical disc by reducing the diffraction loss attributable to the hologram element. Thus, the embodiment of optical pickup can adapt itself to not only signal reproduction but also to signal recording with ease to realize excellent recording/reproduction characteristics.

Thus, the above-described embodiment of optical pickup 50 according to the present invention can bring forth an optimal diffraction efficiency and an optimal diffraction angle by means of a single hologram element so that it can read signals from and write signals on any of the optical discs 11, 12, 13 of different types by means of the matching light beam selected from the light beams of different wavelengths emitted from the plurality of emission sections arranged in the light source sections 51. Additionally, it commonly uses optical parts such as the objective lens for all the optical discs to make it possible to simplify the configuration of and downsize the optical pickup. Thus, the present invention can achieve high productivity and low cost.

Additionally, the above described embodiment of optical pickup 50 according to the present invention can bring forth an optimal diffraction efficiency and an optimal diffraction angle for light beams of a plurality of different wavelengths by means of a single hologram element so that it can commonly use optical parts such as the objective lens for all the optical discs to make it possible to simplify the configuration of and downsize the optical pickup. Thus, the present invention can achieve high productivity and low cost.

Still additionally, in the above described embodiment of optical pickup 50 according to the present invention, the hologram element 33 is provided on the aspherical reference curved surface thereof with a hologram section 33b, the hologram element 33 can be processed with an improved efficiency if compared with conventional hologram elements having a hologram profile that requires a plurality of steps for preparation. Thus, the above-described embodiment of optical pickup 50 can further improve the productivity and reduce the manufacturing cost.

While the first through third emission sections are arranged in one or two light source sections in the above described embodiments of optical pickup 3 or optical pickup 50, the present invention is by no means limited thereto and, for example, all of the first through third emission sections may alternatively be arranged at respective different positions.

A converging optical apparatus according to the present invention includes one or more than one light source sections, an objective lens 32 and a hologram element 33 arranged between the light source section or sections and the objective lens 32 for converging the light beams of the three different types emitted from the first through third emission sections arranged in the light source section or sections and a hologram section 33b is formed on the recess 33a at one of the two surfaces of the hologram element 33, the recess 33a having an aspherical reference curved surface, in order to make the optical pickup 3 compatible with three wavelengths and prevent any fall of the quantity of light of the light beam being converged on the optical disc by reducing the diffraction loss attributable to the hologram element 33. Thus, a converging optical apparatus according to the invention can bring forth an optimal diffraction efficiency and an optimal diffraction angle for light beams of a plurality of different wavelengths by means of a single hologram element so that it can commonly use optical parts such as the objective lens for all the optical discs to make it possible to realize an optical pickup for signal reproduction and signal recording and an optical disc apparatus having a simple configuration and downsized. Thus, the present invention can achieve high productivity and low cost.

An optical disc apparatus 1 according to the invention includes one or more than one light source sections, an objective lens 32 and a hologram element 33 arranged between the light source section or sections and the objective lens 32 for converging the light beams of the three different types emitted from the first through third emission sections arranged in the light source section or sections and a hologram section 33b is formed on the recess 33a at one of the two surfaces of the hologram element 33, the recess 33a having an aspherical reference curved surface, in order to make the optical pickup 3 compatible with three wavelengths and prevent any fall of the quantity of light of the light beam being converged on the optical disc by reducing the diffraction loss attributable to the hologram element 33. Thus, the optical disc apparatus can adapt itself to not only signal reproduction but also to signal recording with ease to realize excellent recording/reproduction characteristics.

Thus, an optical disc apparatus 1 according to the invention can bring forth an optimal diffraction efficiency and an optimal diffraction angle by means of a single hologram element arranged in the optical pickup thereof so that it can record signals on and reproduce signals from any of the optical discs 11, 12, 13 of different types by means of the matching light beam selected from the light beams of different wavelengths emitted from the plurality of emission sections arranged in the light source sections. Additionally, it commonly uses optical parts such as the objective lens for all the optical discs to make it possible to simplify the configuration of and downsize the optical pickup. Thus, the present invention can achieve high productivity and low cost.

### EXAMPLE

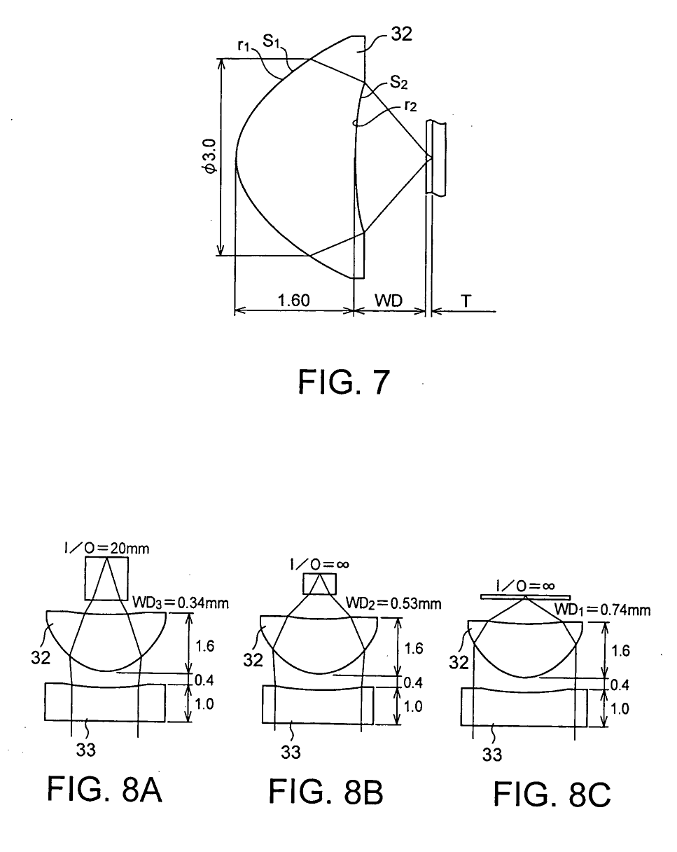

Now, the hologram element 33 and the objective lens 32 of an optical pickup according to the invention will be described more specifically by referring to FIGS. 7 and 8 and the numerical data listed in Tables 1 through 3 shown below.

TABLE 1

| | hologram coefficient |
|---|---|
| C1 | −1.7147E−02 |
| C2 | 2.4681E−03 |
| C3 | 8.7169E−03 |
| C4 | −5.7344E−03 |
| C5 | 2.3280E−03 |

TABLE 2

| | aspherical coefficient |
|---|---|
| c | 0.131 |
| k | −1.0 |
| A | −9.4077E−03 |
| B | −3.3226E−03 |
| C | 2.1858E−02 |
| D | −8.8737E−03 |

TABLE 3

| | S1 | S2 |
|---|---|---|
| r | 1.33737 | 6.48654 |
| k | −0.38627 | −16.5297 |
| A | −3.5645E−03 | −4.6689E−02 |
| B | 2.6174E−03 | 3.5462E−01 |
| C | −1.1319E−02 | −1.1835E+00 |
| D | 1.9685E−02 | 1.6808E+00 |
| E | −1.6661E−02 | −5.7116E−01 |
| F | 3.1738E−03 | −1.2688E+00 |
| G | 2.6161E−03 | 1.7314E+00 |
| H | −1.4267E−03 | −8.6942E−01 |
| J | 1.9881E−04 | 1.6234E−01 |

Table 1 above shows specific values selected for the hologram coefficients of the hologram section 33b of the hologram element 33 in the formula (4) cited above. Table 2 shows specific values selected for the aspherical coefficients of the aspherical shape of the reference curved surface of the hologram section 33b in the formula (2) cited above. The values of Table 1 and those of Table 2 satisfy the relationships of the formula (5) cited above when m=2 and N=1.543.

Table 3 above shows specific values selected for the aspherical coefficients and so on in the formula (1) cited above for the shape of the first surface S₁ located close to the hologram element and aspherical shape of the second surface S₂ located close to the optical disc of the objective lens 32. The values of Table 3 satisfy the relationship of the formula (1) cited above.

The refractive index N₂ of the objective lens 32 varies as a function of wavelength. The refractive index N₂₁ for the first wavelength (405 nm) is 1.83664 and the refractive index N₂₂ for the second wavelength (660 nm) is 1.79597, whereas the refractive index N₂₃ for the third wavelength (780 nm) is 1.78899.

The refractive index N₃ of the first through third optical discs is same for all of the first through third wavelengths and expressed by N₃=1.533.

As for the thicknesses T of the protection substrates of the first through third optical discs, the thickness T₁ of the protection substrate of the first optical disc is 0.1 (mm) and the thickness T₂ of the protection substrate of the second optical disc is 0.6 (mm), whereas the thickness T₃ of the protection substrate of the third optical disc is 1.2 (mm).

FIGS. 8A, 8B, 8C illustrate how the hologram element 33 and the objective lens 32 operate for the first through third optical discs 11, 12, 13 for signal recording and reproduction. As shown in FIGS. 8C and 7, the inter-surface distance between the hologram element 33 and the objective lens 32 is 0.4 mm on the optical axis and the inter-surface distance of the hologram element 33 itself is 1.0 mm on the optical axis, while the inter-surface distance of the objective lens 32 itself is 1.6 mm on the optical axis. As shown in FIG. 7, the diameter of the aperture of the objective lens 32 relative to the light beam of the first wavelength is 3.0 mm.

In FIGS. 7 and 8A through 8C, WD denotes the working distance (mm). The WD₁ for the first optical disc 11 is 0.74 and the WD₂ for the second optical disc 12 is 0.53, whereas the WD₃ for the third optical disc 13 is 0.34.

The I/O distance is ∞ for the light beams of the first and second wavelengths and 20 (mm) for the light beam of the third wavelength. Note that the I/O distance is for the objective lens 32 and the hologram element 33.

This is because the same degree of diffraction (1st degree) is used by the hologram section 33b for the light beams of the second and third wavelengths, the spherical aberration due to the disc thickness and the wavelength difference is corrected by changing the I/O distance.

The optical pickup of the example that shows the numerical data of Tables 1 through 3 realizes a performance expressed by the WDs and the I/O distances listed above.

Thus, the optical pickup can bring forth an optimal diffraction efficiency and an optimal diffraction angle by means of a single hologram element so that it can read signals from and write signals on any of the optical discs of a plurality of different types by means of the matching light beam selected from the light beams of different wavelengths emitted from the plurality of emission sections arranged in one or more than one light source sections. Additionally, it commonly uses optical parts such as the objective lens for all the optical discs to make it possible to simplify the configuration of and downsize the optical pickup. Thus, the present invention can achieve high productivity and low cost.

It should be understood by those skilled in the art that various modifications, combinations, sub-combinations and alterations may occur depending on the design requirements and other factors insofar as they are within the scope of the appended claims or the equivalents thereof.

What is claimed is:

1. A converging optical apparatus comprising:
an objective lens for converging light beams of first through third wavelengths emitted from a light source section on the signal recording surfaces of optical discs; and
a hologram element arranged between the light source section and the objective lens, the hologram element having two major surfaces,
wherein the hologram element is provided with a reference curved surface on one of the major surfaces thereof, the reference curved surface being an aspherical shape, and a hologram section is formed on the reference curved surface.

2. An optical pickup for recording signals on and/or reproducing signals from a plurality of optical discs having respective protection substrates of different thicknesses for protecting the recording surfaces thereof by means of light beams of different wavelengths, the optical pickup comprising:
a first emission section that emits a light beam of a first wavelength;
a second emission section that emits a light beam of a second wavelength;
a third emission section that emits a light beam of a third wavelength;
an objective lens for converging the light beams of the first through third wavelengths emitted respectively from the first through third emission sections on the signal recording surfaces of the optical discs; and
a hologram element arranged between the first through third emission sections and the objective lens, the hologram element having two major surfaces,
wherein the hologram element is provided with a reference curved surface on one of the major surfaces thereof, the reference curved surface being an aspherical shape, and a hologram section is formed on the reference curved surface.

3. The optical pickup according to claim 2, wherein
the first wavelength is about 405 nm,
the second wavelength is about 660 nm, and
the third wavelength is about 780 nm.

4. The optical pickup according to claim 2 or 3, wherein diffracted light of different degrees of diffraction are emitted from the hologram section for the light beams of the first through third wavelengths.

5. The optical pickup according to claim 2 or 3, wherein
diffracted light of the second degree is used by the hologram section for the light beam of the first wavelength and
diffracted light of the first degree is used by the hologram section for the light beams of the second and third wavelengths.

6. The optical pickup according to claim 2 or 3, wherein
the light beam of the first wavelength is turned to collimated light by the hologram element and
the light beams of the second and third wavelengths are turned to divergent light by the hologram element.

7. The optical pickup according to claim 2 or 3, wherein
the quantity of diffracted light of the second degree is made substantially equal to 100% when the light beam of the first wavelength emitted from the first emission section passes through the hologram section and
diffracted light of the second degree is emitted toward the objective lens without changing the angle of divergence as the diffraction angle due to the hologram section and the refraction angle due to the aspherical reference curved surface offset each other.

8. The optical pickup according to claim 2 or 3, wherein
the objective lens is formed so as not to give rise to any aberration to the light beam of the first wavelength and
the hologram section corrects the aberrations of the light beams of the second and third wavelengths.

9. The optical pickup according to claim 2, wherein
the aspherical shape of the reference curved surface satisfies the requirement of formula (1) below:
$$Z ( x ) = \frac{{cx}^{2}}{1 + \sqrt{1 - ( 1 + k )} {c}^{ 2} {x}^{ 2}} + {Ax}^{4} + {Bx}^{6} + {Cx}^{8} + {Dx}^{10} , \qquad ( 1 )$$
where
c: radius of curvature,
k: cone coefficient
A through D: aspherical coefficients
x: distance from the optical axis and
Z(x): sag of the aspherical surface.

10. The optical pickup according to claim 2, wherein the hologram section is formed to show a blaze-like profile.

11. An optical disc apparatus including an optical pickup for recording signals on and/or reproducing signals from a plurality of optical discs having respective protection substrates of different thicknesses for protecting the recording surfaces thereof, and disc rotary drive means for driving an optical disc to rotate,
wherein the optical pickup comprises:
a first emission section that emits a light beam of a first wavelength;
a second emission section that emits a light beam of a second wavelength;
a third emission section that emits a light beam of a third wavelength;
an objective lens for converging the light beams of the first through third wavelengths emitted respectively from the first through third emission sections on the signal recording surfaces of the optical discs; and
a hologram element arranged between the first through third emission sections and the objective lens, the hologram element having two major surfaces,
wherein the hologram element is provided with a reference curved surface on one of the major surfaces thereof, the reference curved surface being an aspherical shape, and a hologram section is formed on the reference curved surface.
